(19) United States
(12) Patent Application Publication
(10) Pub. No.: US 2015/0286342 A1
(43) Pub. Date: Oct. 8, 2015

(54) SYSTEM AND METHOD FOR DISPLAYING APPLICATION DATA THROUGH TILE OBJECTS

(71) Applicant: Kobo Inc., Toronto (CA)

(72) Inventors: Robert MacArthur, Milton (CA); Nina Rehula, Toronto (CA); Ralph Sobanski, Toronto (CA)

(73) Assignee: Kobo Inc., Toronto (CA)

(21) Appl. No.: 14/248,129

(22) Filed: Apr. 8, 2014

(51) Int. Cl. G06F 3/0481; G06F 3/0484; G06F 3/0488; G06F 3/0482

(52) U.S. Cl. CPC G06F 3/0481; G06F 3/0482; G06F 3/04842; G06F 3/04845; G06F 3/0488

(57) ABSTRACT

A computing device operates to associate each of multiple applications with a corresponding tile object. Each of the multiple applications are executed to generate application data, which is displayed in the corresponding tile object. The tile object for each of multiple applications is displayed at one time. A size of a first tile object for a first application can be increased in response to user input while the tile objects for at least some of the other applications is displayed.

### TECHNICAL FIELD

Examples described herein relate to a system and method for displaying application data through tile objects.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

In some instances, e-readers are purpose built devices designed especially to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for providing content to a mobile computing device, according to an embodiment.

FIG. 2 illustrates an example of a mobile computing device for use with one or more embodiments described herein.

FIG. 3 illustrates an example device system for implementing a tile framework on a mobile computing device, according to an embodiment.

FIG. 4 illustrates an example method for implementing a tile framework, according to one or more embodiments.

FIG. 5A through FIG. 5G illustrate implementations of tile objects, in accordance with one or more embodiments.

### DETAILED DESCRIPTION

Embodiments described herein include a computing system that provides multiple tile objects to render application data from different applications at one time. The tile objects can be used by a user to view application data from multiple applications at one time, so that the user does not have to dedicate a display screen to view application data from a single application. By way of example, the tile objects can be provided as part of an application launch screen or home screen to facilitate user interaction with the computing device.

According to some embodiments, the tile objects are independently configurable in dimension and other attributes. For example, user input can cause a select tile object to be enlarged on the display screen, while application data from other applications are continued to be rendered through other tile objects that are visible on the screen at the same time.

According to an embodiment, a computing device operates to associate each of multiple applications with a corresponding tile object. Each of the multiple applications are executed to generate application data, which is displayed in the corresponding tile object. The tile object for each of multiple applications are displayed at one time. A size of a first tile object for a first application can be increased in response to user input while the tile objects for at least some of the other applications is displayed.

In some embodiments, when the size of the first tile object is increased, an amount of the application data that can be viewed through the first tile object is also increased.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory.

Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

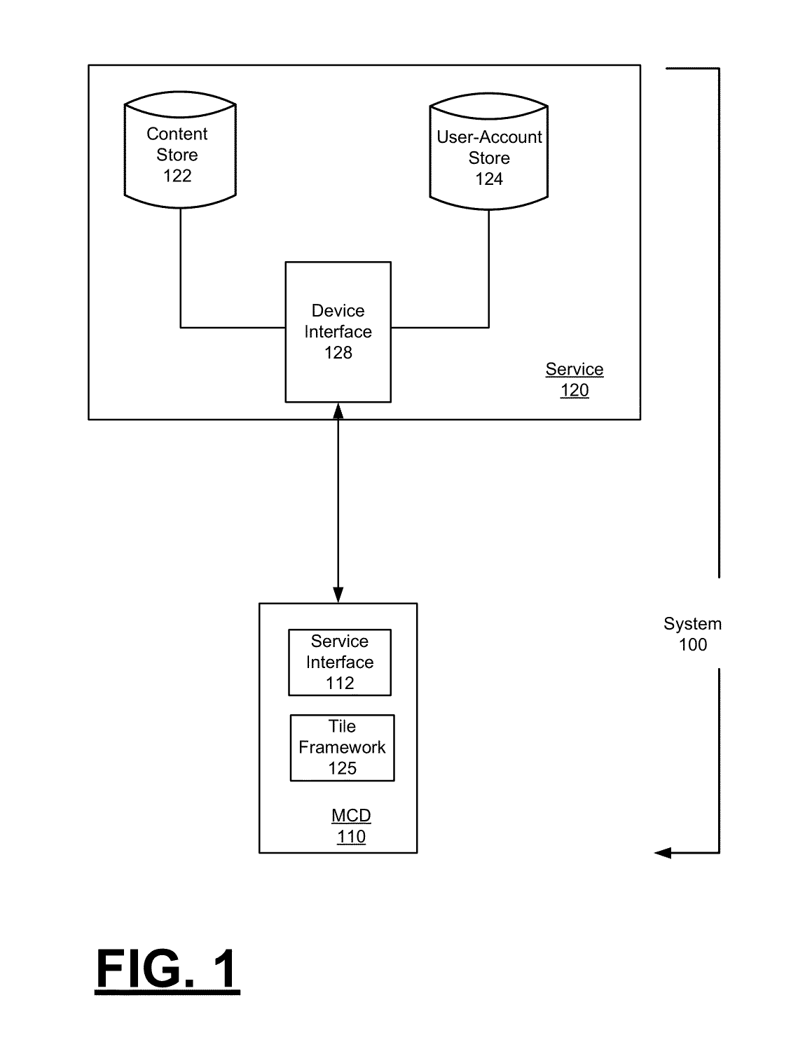

FIG. 1 illustrates a system for providing content on a mobile computing device, according to an embodiment. In an example of FIG. 1, system 100 includes a mobile computing device 110 and a network service 120. The network service 120 may include multiple servers and other computing resources that provide various services in connection with one or more applications that are installed on the mobile computing device 110. By way of example, in one implementation, the network service 120 can provide e-book services which communicate with corresponding e-book functionality provided on the mobile computing device 110. The e-book services can enable e-books to be downloaded or archived from mobile computing device 110. The network service 120 can also provide other forms of content for download or streaming, such as videos or music. In this way, the network service 120 can provide various other content services, including content rendering services (e.g., streaming media) or other network-application environments or services.

The mobile computing device 110 can correspond to any electronic personal display device on which applications and application resources (e.g., e-books, media files, documents) can be rendered and consumed. For example, the mobile computing device 110 can correspond to a tablet or a telephony/messaging device (e.g., smart phone). In one implementation, for example, mobile computing device 110 can run an e-reader application that links the device to the network service 120 and enables e-books provided through the service to be viewed and consumed. In another implementation, the mobile computing device 110 can run a media playback or streaming application which receives files or streaming data from the network service 120. By way of example, the mobile computing device 110 can be equipped with hardware and software to optimize certain application activities, such as rendering of electronic content (e.g., e-books). For example, the mobile computing device 110 can have a tablet like form factor, although variations are possible. In some cases, the mobile computing device 110 can also have an E-ink display.

In additional detail, the network service 120 can include a device interface 128, a resource store 122 and a user account store 124. The user account store 124 can associate the mobile computing device 110 with a user and with an account 125. The account 125 can also be associated with one or more application resources (e.g., content item such as an e-books), which can be stored in the resource store 122. As described further, the user account store 124 can retain metadata for individual accounts 125 to identify resources that have been purchased or made available for consumption for a given account. The mobile computing device 110 may be associated with the user account 125, and multiple devices may be associated with the same account. As described in greater detail below, the mobile computing device 110 can store resources (e.g., e-books) that are purchased or otherwise made available to the user of the mobile computing device 110, as well as to archive e-books and other digital content items that have been purchased for the user account 125, but are not stored on the particular computing device.

The mobile computing device 110 can include a service interface 112 to receive resources and data from the network service 120. The service interface 112 can identify, for example, the user and an account number with the network service 120. The service interface 112 can interface with the network service 120 to receive resources such as applications and content items (e.g., e-books, music files, etc.) from the network service. The mobile computing device 110 can communicate with multiple services in order to receive resources.

According to some embodiments, the mobile computing device 110 implements a tile framework 125 to enhance the presentation of applications and application data. Further, the tile framework 125 enables a user to select applications for execution, and or to view application data from one or more applications running at the same time. As described with examples provided below, the tile framework 125 generates configurable tile objects that render application data from applications that are running on the mobile computing device 110. In particular, the tile framework 125 enables individual tile objects to be linked to applications to render application data, and further to be altered in dimension based on user input. Thus, the user can expand individual tiles to view more application data, and/or view the collection of active tiles in order to select applications for exclusive use. In some implementations, the tile framework 125 enables an interface for either an application launcher or home screen.

Hardware Description

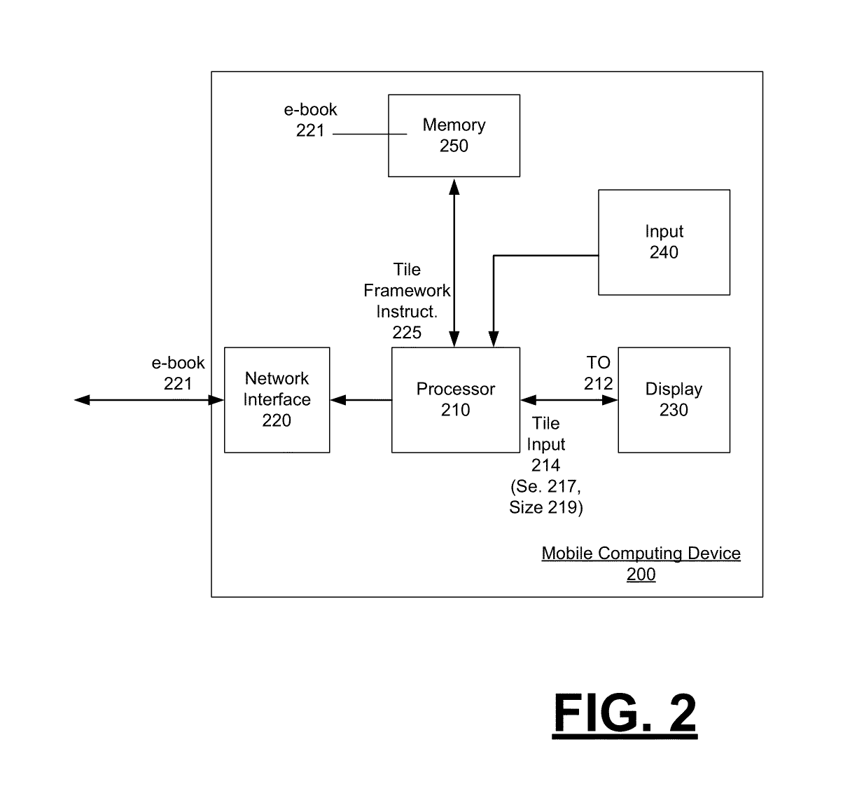

FIG. 2 illustrates an example of a mobile computing device for use with one or more embodiments described herein. In an example of FIG. 2, a mobile computing device 200 can correspond to, for example, a mobile computing device such as shown by an example of FIG. 1.

With reference to FIG. 2, mobile computing device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the mobile computing device 200 can access the network service 120 to receive various kinds of resources (e.g., digital content items such as e-books, configuration files, account information), as well as to provide information (e.g., user account information, service requests etc.). For example, mobile computing device 200 can receive application resources, such as media files 221 (e.g., e-books) that the user elects to purchase or otherwise download from the network service 120. The application resources that are downloaded onto the mobile computing 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“tile framework instructions 225”) for enabling the tile framework 125. The processor 210 can execute the tile framework instructions 225 to generate one or more tile objects 212, which are then rendered on the display 230. The processor 210 can render the tile objects 212 to be interactive, so as to process tile input 214 entered by the user through the display 230. The tile input 214 can specify, for example, selection input 217 to associate an application with a tile object, and/or size input 219 to enable the user to adjust the size of a particular tile object. The processor 210 can execute the tile framework instructions 225 to enable individual tile objects to be re-sized, and further to determine the application data or content that is to be provided through the selected tile object.

Device System

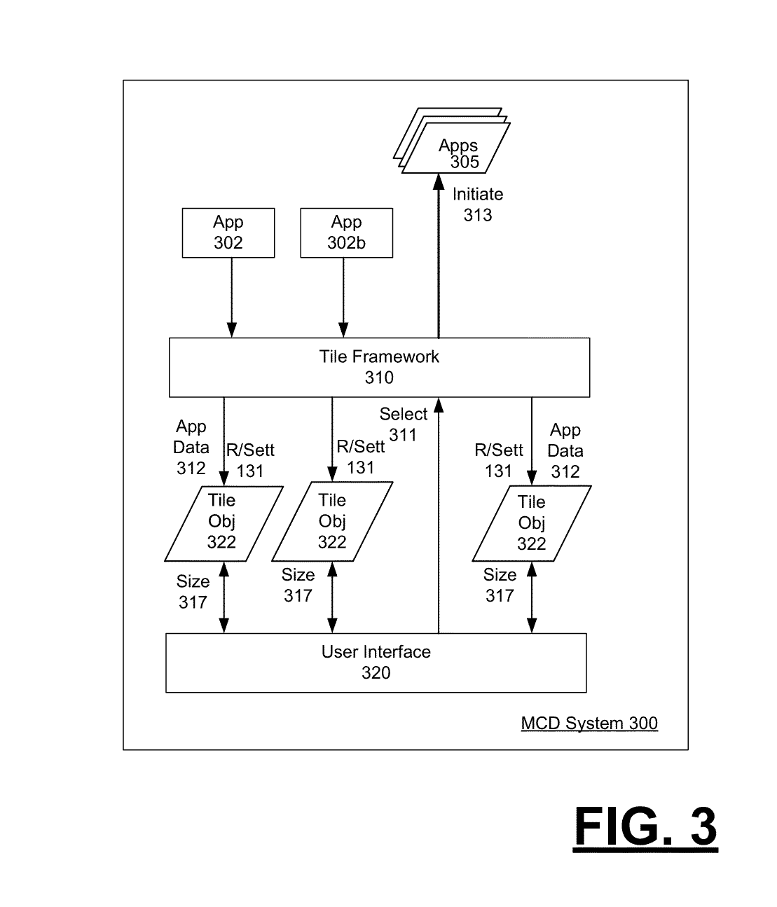

FIG. 3 illustrates an example device system for implementing a tile framework on a mobile computing device, according to an embodiment. In reference to FIG. 3, a system 300 implements programmatic components for communicating with one or more network service (such as network service 120, shown in FIG. 1), as well as for enabling functionality for viewing and accessing content items (e.g., e-books) utilized by an account associated with the mobile computing device 110 (see FIG. 1). In some embodiments, the system 300 can be implemented as an application that runs on a mobile computing device, such as shown with examples of FIG. 1 or FIG. 2. In variations, the system 300 can be implemented as part of the operating system for the mobile computing device.

In more detail, system 300 includes a tile framework 310 and a user interface 320. The tile framework 310 operates to maintain tile objects 322, which can be selectively linked to applications that reside on the mobile computing device. Each tile object 322 corresponds to a programmatic element that controls a display region for purpose of displaying application data from a linked application. The tile objects 322 can have attributes, including dimensional attributes, which can be configurable by user input. The tile framework 310 can link individual tile objects 322 with corresponding applications 302 resident on the computing device for purpose of displaying application data from individual applications through the linked tile object.

According to embodiments, the tile framework 310 can maintain multiple tile objects in a variety of states. In particular, a tile object 322 can have (i) a disassociated state, where the tile object 322 is empty and not linked to a particular application; (ii) an inactive state, where the tile object 322 displays data for an application that is inactive (e.g., not running); and (iii) an active state, where the tile object 322 displays application data for a linked application that is running on the mobile computing device.

The user interface 320 can display the tile objects 322 as a collection, and further enable user input and interaction to (i) link (or unlink) applications and tile objects, and (ii) view and/or manipulate tile objects (including altering attributes such as dimension). By way of example, the user interface 320 can be implemented as an application launcher or home screen for mobile computing device. In one implementation, the user interface 320 processes selection input 311 from the user. The selection input 311 can specify input to link (or unlink) a tile object 322 with a corresponding application. In some variations, the specified tile object 322 can be individually specified by, for example, the location of the selected tile relative to other tile objects. The selection input 311 can be communicated to the tile framework 310. The tile framework 310 accesses the application library 305 for the device to link the application specified by the selection input 311 with the particular tile object 322. The tile framework 310 can also initiate 313 the selected application 302 to execute.

In one implementation, the tile framework 310 directs application data 312 generated from execution of the application 302 to the selected tile object 322. The tile framework 310 can implement a programmatic conduit to direct the application data 312 to the selected tile object 322. The tile object 322 frames the application data 302 to the dimensions of the tile object 302.

Additionally, the tile framework 310 and/or tile object 322 can perform operations to select or filter the application data 312 that is to be made visible through the tile object 322. The selection or filtering can be based on the dimension of the tile object 322, which can vary between a minimum and maximum range, depending on user input and/or settings. Thus, the tile object 322 can be selective in what application data is displayed, based on the dimension of the tile object.

The user interface 320 can process size input 317 from the user to after the dimension of a particular tile object 322. The size input 317 can be implemented temporarily (e.g., for a session) or persistently. The size input 317 can configure the size of a particular tile object from a default dimension (e.g., minimum size) to multiple intermediate dimensions until a maximum dimension is reached (e.g., entire screen). In one implementation, the intermediate positions are provided at discrete intervals, so that the dimension of the tile object increases from one dimension to the next. In a variation, the dimension of the tile object can vary to an extent that the change in the dimension of the tile object appears as a continuum from a minimum to a maximum, with numerous intermediate positions available to display the tile object. In an embodiment, when a particular tile object 322 is re-sized, the amount of application data that is rendered through the tile object is also changed. For example, if the tile object is made larger, then the amount of application data provided through the tile object is also made greater. The tile framework 310 and/or tile object 322 can implement rules or settings 331 that determine the selection of application data that is to be made visible through a given tile object at a given dimension.

In one implementation, the tile framework 310 and/or tile object 322 can implement rules or settings 331 in order to determine what application data 312 is to be displayed on a given tile object 322 based on the dimensions of the tile object 322. In some implementations, the rules or settings 331 can be specific to the application or category of application. The rules or settings 331 can be used to determine (i) the data set that is to be displayed from an application given the particular size of the tile object 322, and (ii) how the selected data set is to be manipulated for the tile object 322 given the size of the particular tile object 322. By way of example, the rules or settings 331 for a tile object that displays an e-book can specify that the tile object is to display words in sequence from individual lines of text in wrapped format until the size of the tile object is above a threshold, at which point a portion of a page can be displayed. As another example, the tile object for a weather application can specify that the temperature and weather icon (e.g., sunny, rainy etc.) are to be displayed when the tile object 322 is at a minimum size, and when the tile object is larger than a threshold, the 5-day forecast is displayed. The rules and settings 331 can specify that in between thresholds, the data on display can be enlarged with increase in dimension of the tile object 322 due to size input 317.

Still further, the rules and settings 331 can specify (i) priority in the application data that is to be made visible (e.g., display top of page first and expand downward with expansion of tile object), and (ii) data type that is to be made visible (e.g., display text but not image). The rules and settings 331 can also specify dimensional thresholds that trigger variation in the rule or setting (e.g., display image only when tile object is increased by 25%). Thus, the size of the individual tile objects can serve as a selection criterion for determining what application data is made visible through the particular tile object 322.

Methodology

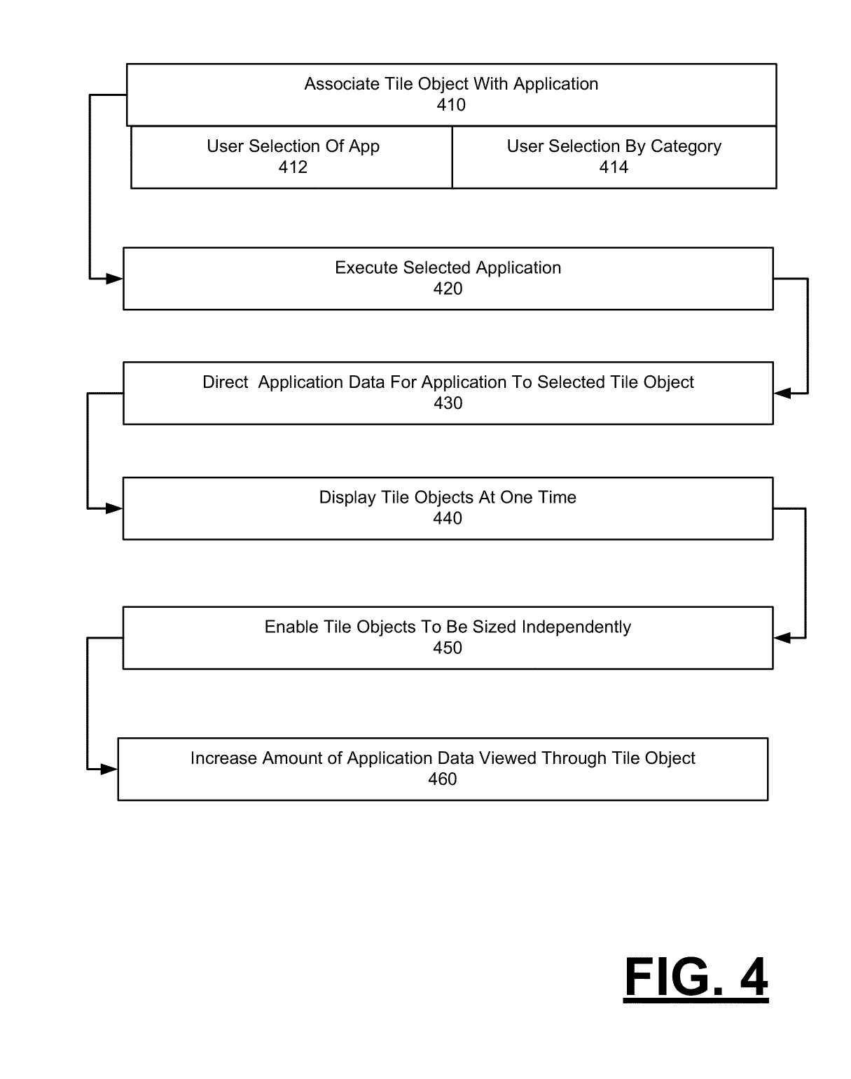

FIG. 4 illustrates an example method for implementing a tile framework, according to one or more embodiments. In describing an example of FIG. 4, reference may be made to elements described with FIG. 3 and other figures, for purpose of illustrating suitable components for performing a step or sub-step being described.

With reference to FIG. 4, a tile object 322 can be linked with an application from the application library (410). Prior to the association, the tile object 322 can have a disassociated state, meaning it is not assigned to a particular application. Alternatively, the user input can re-assign the tile object 322 to a new application. The association can be made by way of user selection (412). For example, a user can select a particular tile object, then specify input to link to a particular application. In a variation, the user selects a tile object, and then selects a category for the tile object (414). In one implementation, the mobile computing device can automatically designate applications for categories.

When the tile object 322 is linked to a particular application, the application is executed so that it is in an operational state (420). For example, the tile framework 310 can initiate the selected application to execute. Alternatively, the application can be in an operational state when the link is made, and the tile object 322 can be linked to the application in the operational state.

The application data for the selected application is then displayed through the selected tile object (430). The tile framework 310 can implement a programmatic conduit in which application data generated by the selected application is directed to the selected tile object 322. The selected tile object 322 can then be displayed through the user interface 320 as an active tile object.

The tile framework 310 can maintain multiple tile objects 322 of different states. In one implementation, the tile framework 310 maintains a collection of tile objects. The tile objects 322 can include those that are disassociated, inactive or active. The user interface 320 can display multiple tile objects 322 at one time (440), including tile objects that are active, inactive, and disassociated.

The tile objects 322 can be independently sized based on user input (450). In one implementation, the tile objects 322 are displayed through the user interface 320, and the user can provide input to interact with the tile objects. In particular, the user can expand or shrink a selected tile object 322, thus changing a dimension of the selected tile object 322 relative to other tile objects 322 that are displayed at the same time. In one implementation, for example, tile objects 322 can be displayed in the form of a panel of tile objects, so that multiple tile objects are displayed at one time. A given tile object 322 can be enlarged relative to other tile objects so that it occupies more of the overall display area. As a tile object is enlarged, other tile objects can be pushed off screen (to bottom or side) in order to accommodate the new dimensions of the enlarged tile object.

When a given tile object is increased in dimension, the amount of application data displayed through the particular tile object is also increased (460). The increase in the amount of application data that can be displayed through the selected tile object can correspond to, for example, additional text, images or content. Thus, more data is made available through the selected tile object, rather than enlarging existing content for the new dimension.

In one implementation, the selected tile object can be increased from a minimum dimension to multiple intermediate dimensions and then to a maximum dimension. At pre-determined size thresholds, the amount of application data displayed through the tile object is increased to reflect the increased size. At the same time, the existing application data can be enlarged with increase of the tile object.

### Examples

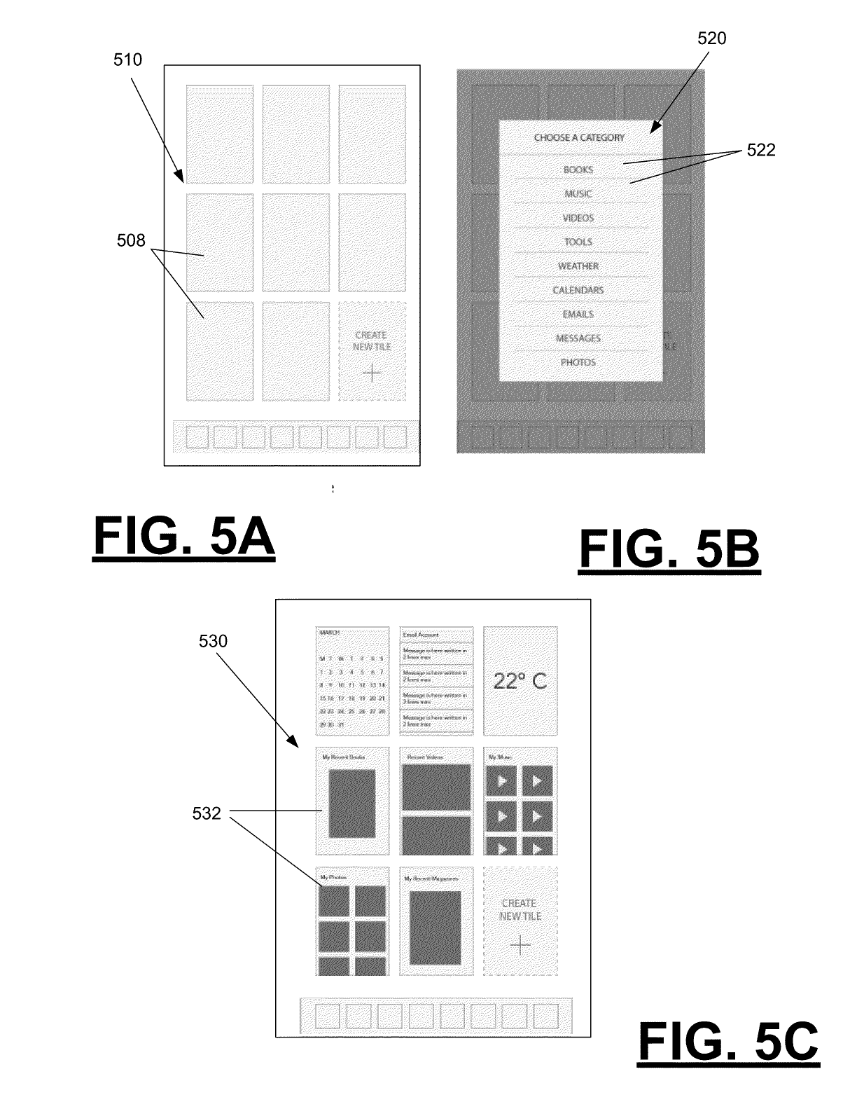

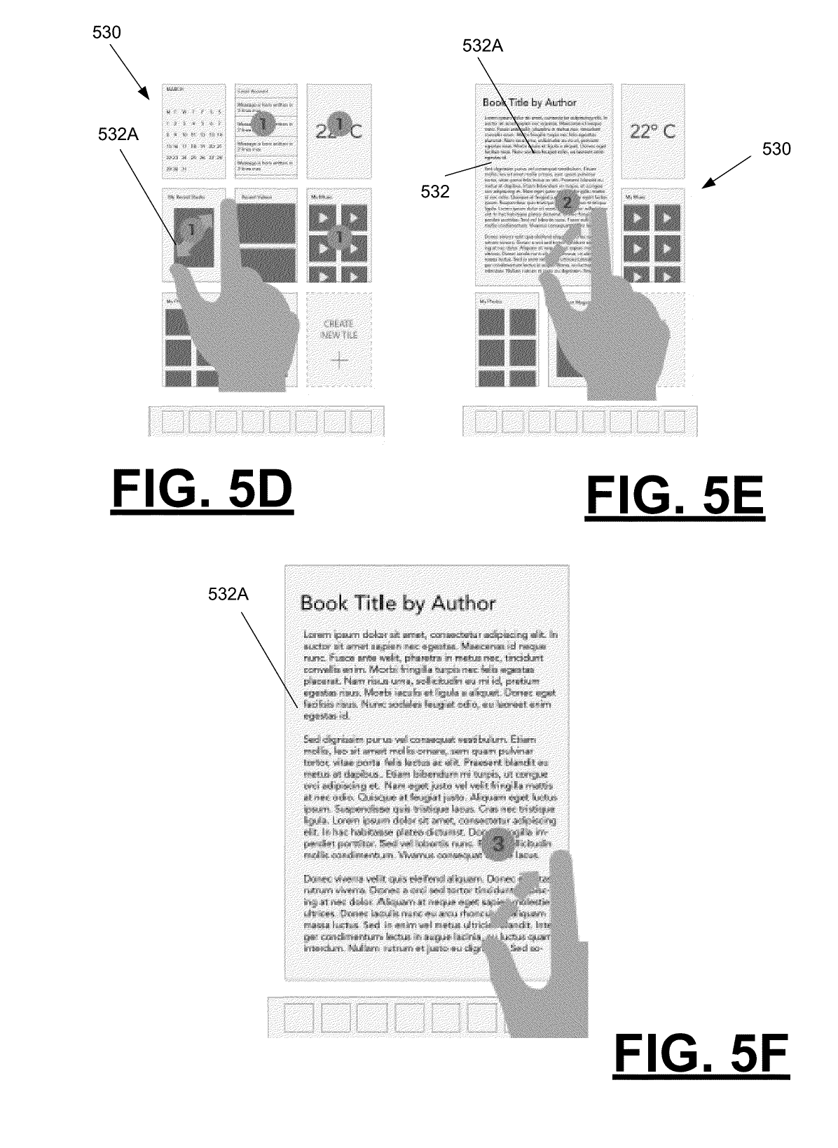

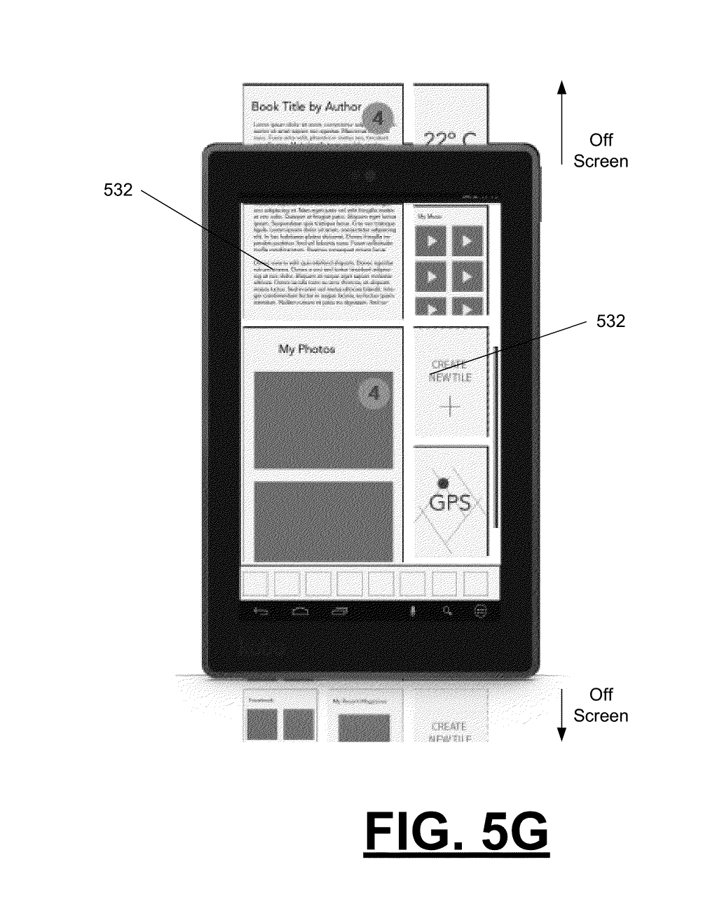

FIG. 5A through FIG. 5G illustrate implementations of tile objects, according to one or more embodiments. Examples such as described by FIG. 5A through FIG. 5G can be implemented using, for example, elements such as described with prior examples, including with FIG. 3.

With reference to FIG. 5A, a display screen 510 can be implemented as part of an application launcher or home page for a mobile computing device. Initially, the display screen can display a panel of tile objects 508 that are in a disassociated state.

In FIG. 5B, a user can select a tile object. In response, one implementation provides a selection interface 520 that displays a list of categories 522 for the user. The user can select a category for a particular tile object.

FIG. 5C illustrates a panel 530 of tile objects 532 that are in an active state. In the example of FIG. 5C, the tile objects are shown to be the same size. Each tile object 532 can display application data from a corresponding application (e.g., calendar application, email application, weather application, e-book application, My Photos, etc.). In one implementation, the configuration of each tile object 532 can be determined from rules and settings 331. In particular, the application data that is viewable through each tile object at the particular dimension can be based on rules and settings 331 (see FIG. 3), which can be managed by the tile frameworks 310. Other configurations, such as a format in which the application data is displayed by the tile object 532, can also be determined by rules and settings 331.

FIG. 5D illustrates user interaction with individual tile objects 532A of the panel 530. The user can select to enlarge a particular file object through touch input (e.g., mufti-touch input) provided on the display screen. FIG. 5E illustrates the expanded tile object 532A. The selected tile object 532A is increased in dimension in response to the input. In one implementation, the dimension of the selected tile object 532A can be increased from a minimum (e.g., see FIG. 5D) to one or more intermediate dimensions (FIG. 5E). In FIG. 5F, the selected tile object 532 can be increased to a maximum dimension (e.g., occupies display screen).

FIG. 5G illustrates an implementation in which tile objects 532 are maintained at different dimensions on a given panel. When the selected tile object is enlarged, an implementation provides that other tile objects are moved off screen to accommodate the enlarged tile object. FIG. 5G illustrates conceptually the manner in which tile objects are pushed off-screen to accommodate enlarged tile objects. The tile objects can be pushed off-screen both vertically and laterally.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a memory that stores a set of instructions;
one or more processors that access instructions in the memory in order to:
associate each of multiple applications with a corresponding tile object;
execute each of the multiple applications to generate application data for each of the multiple applications;
display the application data for each of the multiple applications in the corresponding tile object;
display the tile object for each of multiple applications at one time; and
increase a size of a first tile object for a first application in the multiple applications in response to user input while displaying the tile objects for at least some of the other applications in the multiple applications,
wherein the one or more processors increase the size of the first tile object by also increasing an amount of the application data from execution of the first application that can be viewed through the first tile object.

2. The computer system of claim 1, wherein the one or more processors respond to user input by increasing the size of the first tile object from an original dimension to multiple intermediate dimensions until the first tile object is of a maximum dimension.

3. The system of claim 2, wherein the one or more processors increase the amount of application data that is visible in the selected tile object with the size of the selected tile object being increased.

4. The computer system of claim 1, wherein the one or more processors display the tile object for each of multiple applications as part of a home screen or application launcher.

5. The computer system of claim 1, wherein the one or more processors associate each of the multiple applications with the corresponding tile object based on user input.

6. The computer system of claim 5, wherein the one or more processors receive, for a first tile object, user input corresponding to an application category, and then selects a corresponding application for the first tile objet based on the user input.

7. The computer system of claim 1, wherein the one or more processors increase a size of a second tile object for a second application in the multiple applications in response to user input while displaying the first tile object with the increased size.

8. The computer system of claim 7, wherein the one or more processors display the first tile object and the second tile object, each with their respective increased size, along with the tile objects for multiple other applications.

9. The computer system of claim 2, further comprising:
a display including a touch-sensitive screen; and
wherein the one or more processors respond to user input provided on the touch-sensitive display.

10. A method for providing application data on a computing device, the method being implemented by one or more processors of the computing device and comprising:
associating each of multiple applications with a corresponding tile object;
executing each of the multiple applications to generate application data for each of the multiple applications;
displaying the application data for each of the multiple applications in the corresponding tile object;
displaying the tile object for each of multiple applications at one time; and
increasing a size of a first tile object for a first application in the multiple applications in response to user input while displaying the tile objects for at least some of the other applications in the multiple applications,
wherein increasing the size of the first tile object includes increasing an amount of the application data from execution of the first application that can be viewed through the first tile object.

11. The method of claim 10, wherein increasing the size of the first tile object includes increasing the size of the first tile object from an original dimension to multiple intermediate dimensions until the first tile object is of a maximum dimension.

12. The method of claim 11, wherein increasing the size of the first tile object includes increasing the amount of application data that is visible in the selected tile object with the size of the selected tile object being increased.

13. The method of claim 10, wherein further comprising displaying the tile object for each of multiple applications as part of a home screen or application launcher.

14. The method of claim 10, wherein associating each of multiple applications with the corresponding tile object is based on user input.

15. The method of claim 14, wherein associating each of multiple applications with the corresponding tile object includes receiving, for a particular tile object, user input corresponding to an application category, and then automatically selecting a corresponding application for the particular tile objet based on the user input.

16. The method of claim 10, further comprising increasing a size of a second tile object for a second application in the multiple applications in response to user input while displaying the first tile object with the increased size.

17. The method of claim 16, further comprising displaying the first tile object and the second tile object, each with their respective increased size, along with the tile objects for multiple other applications.

18. The method of claim 11, wherein increasing the size of the first tile object includes receiving multi-touch input on a touch-sensitive display screen of the computing device.

19. A computer-readable medium that stores instructions for providing application data on a computing device, the instruction being executable by one or more processors of the computing device to cause the computing device to perform operations that include:
associating each of multiple applications with a corresponding tile object;
executing each of the multiple applications to generate application data for each of the multiple applications;
displaying the application data for each of the multiple applications in the corresponding tile object;
displaying the tile object for each of multiple applications at one time; and
increasing a size of a first tile object for a first application in the multiple applications in response to user input while displaying the tile objects for at least some of the other applications in the multiple applications,
wherein increasing the size of the first tile object includes increasing an amount of the application data from execution of the first application that can be viewed through the first tile object.

20. The computer-readable medium of claim 19, wherein instructions for increasing the size of the first tile object includes instructions for increasing the size of the first tile object from an original dimension to multiple intermediate dimensions until the first tile object is of a maximum dimension.
